(19) United States
(12) Patent Application Publication
(10) Pub. No.: US 2025/0223230 A1
(43) Pub. Date: Jul. 10, 2025

(54) BIOCERAMIC COMPOSITIONS

(71) Applicant: Multiple Energy Technologies LLC, Washington, PA (US)

(72) Inventors: Shannon VISSMAN, Clearwater Beach, FL (US); Francisco José CIDRAL-FILHO, Washington, PA (US); Francisco DE PAULA MOREIRA, Florianópolis (BR); Steven MIDTTUN, Boca Raton, FL (US)

(21) Appl. No.: 19/025,252

(22) Filed: Jan. 16, 2025

Related U.S. Application Data
(63) Continuation of application No. 17/104,865, filed on Nov. 25, 2020, now Pat. No. 12,234,191.
Application No. 17/104,865 is a continuation of application No. 16/041,449, filed on Jul. 20, 2018, now abandoned.
Application No. 16/041,449 is a continuation of application No. 13/760,546, filed on Feb. 6, 2013, now Pat. No. 10,252,945.
(60) Provisional application No. 61/705,986, filed on Sep. 26, 2012.

(51) Int. Cl. C04B 35/44; C04B 33/04; C08K 3/34; C12H 1/16; D06M 11/45; D06M 11/46; D06M 11/79; D06M 16/00; D06M 23/08; D06M 23/16; D06M 101/34

(52) U.S. Cl. CPC C04B 35/44; C04B 33/04; C08K 3/346; C12H 1/165; D06M 11/45; D06M 11/46; D06M 11/79; D06M 16/00; D06M 23/08; D06M 23/16; C04B 2235/3217; C04B 2235/3244; C04B 2235/3409; C04B 2235/3418; C04B 2235/3427; D06M 2101/34

(57) ABSTRACT

Introduction: Rituximab (R) is an integral component of therapy for B-cell lymphoid malignancies; bortezomib (Btz) has shown provocative single agent activity in Follicular Lymphoma (FL), Mantle Cell Lymphoma (MCL) and Waldenstrom's Macroglobulinaemia (WM), providing the rationale for investigating the combination.

Patients+Methods: Forty-five adult patients (pts.) (30 men, 15 women) with histologically confirmed recurrent CD20+ve FL, MCL or WM, median age 60 years (range 45-79), FL: 17, MCL: 18, WM: 10, stage III/IV 40 (93%), bone marrow (BM) infiltration 32 (73%), elevated LDH 22 (49%), performance status ≥1 22 (49%), were enrolled in a randomised trial comparing 2 schedules of Brz+R: Arm A (twice weekly) Btz: 1.3 mg/m² (on days 1, 4, 8, 11 of a 21-day cycle) and R: 375 mg/m² (on day 1) for 8 cycles, or Arm B (weekly) Btz: 1.6 mg/m² (on days 1, 8, 15, 22 of a 35-day cycle) and R: 375 mg/m² (on days 1, 8, 15, 22 of cycles 1 and 4) for 6 cycles (23 arm A, 22 arm B). The median number of previous treatments was 2 (range 1-7). Seventeen pts. had received a R-containing regimen, with response lasting >6 months, and 8 high-dose treatment. Response was evaluated using the IWR criteria (Cheson et al, JCO 17:1244, 1999) and the updated response criteria from the 3rd International Workshop on WM (Treon et al, Blood 107:3442, 2006)

Results: Ability to deliver the therapy, toxicity and efficacy were equivalent in both arms. The median number of cycles given in arm A was 4 and 5 in arm B. Haematological toxicity (grade≥3: anaemia 0%, neutropenia 25%, thrombocytopenia 22%) was significantly influenced by the high percentage of pts. with BM infiltration and concomitant cytopenia on entry to the trial. The most common non-haematological adverse events were fatigue (76%), nausea (56%), diarrhoea (56%), lethargy (46%). Neurotoxicity occurred in 19 pts. (46%) (10 pts. grade 1, 7 pts. grade 2, 2 pts. grade 3). Btz dose was reduced in 7 pts.; 5 doses were omitted because of neuro or haematological toxicity. In 16 pts., treatment was delayed by 1-14 days and in 24 pts. treatment was stopped prematurely. The reasons for stopping treatment were: treatment-related toxicity 11 pts., progressive disease 9 pts., patient's preference 3 pts., myocardial infarction 1 pt. One pt. was excluded having been found ineligible post randomisation. Thirty-nine pts. (21 arm A, 18 arm B) are evaluable for response so far, one having only received 1 cycle of therapy, which had to be discontinued because of excessive toxicity. 15/32 were in remission (CR, CRu, PR) at the completion of therapy, 7/7 at “mid-therapy” assessment, and 5 have yet to be evaluated. Thus the overall response rate (RR) presently is 22/39 (56%) (CR, CRu, PR), FL 44%, MCL 46%, WM 90%.

Conclusions:

The combination was active in pts. with recurrent NHL especially WM (RR 90%), despite multiple previous treatments, The weekly schedule is preferable being more convenient, as efficacious and no more toxic.

Further investigation is warranted, despite not insignificant therapy compromising toxicity.

### CROSS-REFERENCE

This application is a continuation of U.S. application Ser. No. 17/104,865, filed on Nov. 25, 2020, which is a continuation of U.S. application Ser. No. 16/041,449, now abandoned, filed on Jul. 20, 2018, which is a continuation of application Ser. No. 13/760,546, filed on Feb. 6, 2013, now issued as U.S. Pat. No. 10,252,945 on Apr. 9, 2019, which claims the benefit of U.S. Provisional Application No. 61/705,986, filed Sep. 26, 2012, the contents of each are incorporated herein by reference for all purposes.

### BACKGROUND

In 1800, Dr. F. W. Herschel of Great Britain found and reported to the academic world a wavelength ranging from 0.7 to 1000 microns, just beyond visible light, called infrared, which has strong physical properties and great thermal activity. The natural resonant frequency range of water and living organisms, including man, falls within the infrared range. For example, the wavelength range of 6-18 μm is well known to be beneficial to the human body by virtue of its activating and energizing effect on the body. Indeed, human skin radiates 9.36 μm infrared wave which is very close to the resonant frequency of a water molecule—and rightly so since our bodies are about 70% water. Infrared waves can be the safest and most beneficial energy source available.

According to The National Center for Complementary and Alternative Medicine (NCCAM), “some CAM practices involve manipulation of various energy fields to affect health. Such fields may be characterized as veritable (measurable) or putative (yet to be measured). Practices based on veritable forms of energy include those involving electromagnetic fields (e.g., magnet therapy and light therapy).” (What is Complementary and Alternative Medicine? (October 2008). Retrieved Aug. 31, 2012, from www.ncaam.nih.gov/health/whatiscam).

Bioceramics include ceramics which radiate beneficial infrared waves. Because of their advantages to human health, bioceramics are now used for various purposes including biomedicine and living necessaries. These aim to utilize the effects of the infrared radiation emitted therefrom, including, for example, maintenance of freshness of foods, deodorization, vitalization, etc. There is a need therefore, to develop additional bioceramic compositions and uses thereof that provide additional beneficial effects.

### SUMMARY OF THE INVENTION

There is provided in accordance with various embodiments a bioceramic composition that includes from about 45 wt % to about 55 wt % kaolinite (Al₂Si₂O₅(OH)₄); from about 5 wt % to about 15 wt % tourmaline; from about 3 wt % to about 13 wt % aluminum oxide (Al₂O₃); from about 11 wt % to about 19 wt % silicon dioxide (SiO₂); and from about 3 wt % to about 13 wt % zirconium oxide (ZrO₂), wherein the amounts are by total weight of the composition. In one embodiment, the amount of kaolinite ranges from about 45 wt % to about 50 wt % by total weight of the composition. In another embodiment, the amount of kaolinite ranges from about 51 wt % to about 55 wt % by total weight of the composition. In yet another embodiment, the amount of kaolinite ranges from about 47 wt % to about 53 wt % by total weight of the composition. In a further embodiment, the largest dimension of any particle in the composition is from about 0.5 μm to about 25 μm.

Also presented herein is an article that includes: (a) a substrate; and (b) a bioceramic composition that includes particles dispersed throughout the substrate, wherein the bioceramic composition includes from about 45 wt % to about 55 wt % kaolinite (Al₂Si₂O₅(OH)₄); from about 5 wt % to about 15 wt % tourmaline; from about 3 wt % to about 13 wt % aluminum oxide (Al₂O₃); from about 11 wt % to about 19 wt % silicon dioxide (SiO₂); and from about 3 wt % to about 13 wt % zirconium oxide (ZrO₂), wherein the amounts are by total weight of the bioceramic composition. In one embodiment, the substrate includes at least one elastomer. In another embodiment, the substrate includes a polymer that is selected from polyoxybenzylmethylenglycolanhydride, polyvinyl chloride, polystyrene, polyethylene, polypropylene, polacrylonitrile, polylactic acid, and polyvinyl butyral. In yet another embodiment, the elastomer is selected from polychloroprene, nylon, a polyvinyl chloride elastomer, a polystyrene elastomer, a polyethylene elastomer, a polypropylene elastomer, a polyvinyl butyral elastomer, silicone, a thermoplastic elastomer, and combinations thereof.

In a further embodiment, the substrate includes a material selected from wool, silk, cotton, canvas, jute, glass, nylon, polyester, acrylic, elastane, polychloroprene, expanded polytetrafluoroethylene-containing laminate fabrics, and combinations thereof. In yet another embodiment, the substrate includes a metal selected from zinc, molybdenum, cadmium, scandium, titanium, vanadium, chromium, manganese, iron, cobalt, nickel, copper, zirconium, niobium, ruthenium, rhodium, palladium, silver, tantalum, tungsten, rhenium, osmium, iridium, platinum, gold, aluminum, gallium, indium, tin, and combinations thereof.

In one embodiment, the article is selected from apparel, jewelry, patches (e.g. patches that are fabricated to adhere to skin, such as transdermal patches, transdermal hydrogel patches, etc.), pads, insoles, bedding, body supports, foam rollers, lotions, soaps, tape, glassware, furniture, paints, inks, labels, carpets, mats, food and/or beverage containers, drink koozies, headware (e.g. helmets, hats, etc.), footwear (e.g. socks, shoes, etc.), gloves, and earphones. In another embodiment, the substrate includes a polymer and has a shape that is configured to receive a beverage container. In yet another embodiment, the article further includes at least one light emitting diode (LED), at least one magnet, or a combination thereof.

Also presented is a method for preparing a polymeric article that includes the steps of: (a) mixing a bioceramic composition that includes from about 45 wt % to about 55 wt % kaolinite (Al₂Si₂O₅(OH)₄); from about 5 wt % to about 15 wt % tourmaline; from about 3 wt % to about 13 wt % aluminum oxide (Al₂O₃); from about 11 wt % to about 19 wt % silicon dioxide (SiO₂); and from about 3 wt % to about 13 wt % zirconium oxide (ZrO₂), wherein the amounts are by total weight of the bioceramic composition, with a polymeric substrate while the substrate is in a liquid or fluid form; and (b) molding the polymeric substrate into a final shape or form. In one embodiment, the amount of kaolinite ranges from about 45 wt % to about 50 wt % by total weight of the bioceramic composition. In another embodiment, the amount of kaolinite ranges from about 51 wt % to about 55 wt % by total weight of the bioceramic composition. In yet another embodiment, the amount of kaolinite ranges from about 47 wt % to about 53 wt % by total weight of the bioceramic composition. In a further embodiment, the method further includes exposing the article to an electromagnetic signal at a frequency that is between about 0.05 Hz and about 20 MHz for a period of time from about 5 minutes to about 10 minutes.

Also presented is a method for reducing furfural content in a beverage by: exposing a beverage containing furfural to a bioceramic composition that includes from about 45 wt % to about 55 wt % kaolinite (Al₂Si₂O₅(OH)₄); from about 5 wt % to about 15 wt % tourmaline; from about 3 wt % to about 13 wt % aluminum oxide (Al₂O₃); from about 11 wt % to about 19 wt % silicon dioxide (SiO₂); and from about 3 wt % to about 13 wt % zirconium oxide (ZrO₂), wherein the amounts are by total weight of the bioceramic composition, for a time period suitable to reduce the furfural content.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is an electron microscopy image of a bioceramic composition prepared in accordance with various embodiments at 500× magnification;

FIG. 2 is a graph of the spectral transmittance of the bioceramic composition also analyzed in FIG. 1 deposited on a cloth substrate (88% polyamide and 12% elastane);

FIG. 3 is a graph of the spectral transmittance of the bioceramic composition also analyzed in FIG. 1 (impregnated in fabric);

FIG. 4 is a front view of a beverage container inside a beverage koozie;

FIG. 5 is a mass spectrum of a 10 mL beer sample prior to exposure to a bioceramic composition;

FIG. 6 is a mass spectrum of furfural;

FIG. 7 is an overlay of (a) the mass spectrum of a 10 mL beer sample prior to exposure to a bioceramic composition and (b) the mass spectrum of furfural; and

FIG. 8 is an overlay of (a) a mass spectrum of the 10 mL beer sample following exposure to a bioceramic composition and (b) the mass spectrum of furfural.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.”

The biological effects of bioceramics are based on the fact that the infrared frequency range is the natural resonant frequency range of water and living organisms. Because a considerable part of living organisms includes water, the resonant frequency of water molecules radiated from bioceramics can activate the water and affect living organisms.

This document describes bioceramic compositions that include from about 45 wt % to about 55 wt % of kaolinite (Al₂Si₂O₅(OH)₄); from about 5 wt % to about 15 wt % of tourmaline; from about 3 wt % to about 13 wt % of aluminum oxide (Al₂O₃); from about 11 wt % to about 19 wt % by weight of silicon dioxide (SiO₂); and from about 3 wt % to about 13 wt % zirconium oxide (ZrO₂), wherein the amounts are by total weight of the composition. In one embodiment, the amount of kaolinite in the bioceramic composition is selected from approximately 45 wt %, 46 wt %, 47 wt %, 48 wt %, 49 wt %, 50 wt %, 51 wt %, 52 wt %, 53 wt %, 54 wt %, and 55 wt % by total weight of the composition. In another embodiment, the amount of kaolinite ranges from about 45 wt % to about 50 wt % by total weight of the composition. In yet another embodiment, the amount of kaolinite ranges from about 51 wt % to about 55 wt % by total weight of the composition. In a further embodiment, the amount of kaolinite ranges from about 47 wt % to about 53 wt % by total weight of the composition. In one embodiment, the largest dimension of any particle in the bioceramic composition ranges from about 0.5 μm to about 25 μm. In another embodiment, the largest dimension of any particle in the bioceramic composition ranges from about 1 p m to about 20 μm. In yet another embodiment, the largest dimension of any particle in the bioceramic composition ranges from about 2 μm to about 15 μm.

As used herein, the term “tourmaline” retains its meaning known in the mineral and gemstone arts. For example, Tourmaline, according to “The Mineral & Gemstone Kingdom” website (www.minerals.net/tourmaline chemical formula.aspx), is “a group of isomorphous minerals with an identical crystal lattice. Each member of the Tourmaline group has its own chemical formula, due to small differences in their elemental distribution.” According to language taken directly from the website:

A simple generic formula for the Tourmaline group is: X₁Y₃Al₆(BO₃)₃Si₆O₁₈(OH)₄

Where: X=Na and/or Ca and Y=Mg, Li, Al, and/or Fe²⁺

This creates the formula: (Na,Ca)(Mg,Li,Al,Fe²⁺)₃Al₆(BO₃)₃Si₆O₁₈(OH)₄

In some less common varieties, the Al may be replaced by other elements. For example, in Uvite, the Al is partially replaced by Mg.

This expands the formula to: (Na, Ca)(Mg,Li,Al,Fe²⁺)₃(Al,Mg,Cr)₆(BO₃)₃Si₆O₁₈(OH)₄

[ ] Buergerite contains three O atoms and one F atom in place of the OH radical. A Buergerite molecule also contains an Fe atom that is in a 3+ oxidation state.

This further expands the formula to: (Na,Ca)(Mg,Li,Al,Fe₂₊,Fe₃₊)₃(Al,Mg,Cr)₆(BO₃)₃Si₆O₁₈(OH,O,F)₄

Finally, the website provides the chemical formulae of individual members of the Tourmaline group:
Schorl: NaFe²⁺₃Al₆(BO₃)₃Si₆O₁₈(OH)₄
Dravite: NaMg₃Al₆(BO₃)₃Si₆O₁₈(OH)₄
Elbaite: Na(Li,Al)₃Al₆(BO₃)₃Si₆O₁₈(OH)₄
Liddicoatite: Ca(Li,Al)₃Al₆(BO₃)₃Si₆O₁₈(OH)₄
Uvite: Ca(Mg,Fe²⁺)₃Al₅Mg(BO₃)₃Si₆O₁₈(OH)₄
Buergerite: NaFe³⁺₃Al₆(BO₃)₃Si₆O₁₈O₃F

Various embodiments also include articles that incorporate a bioceramic composition. In one embodiment, the bioceramic composition is present as a coating on at least a portion of the surface of the article or is incorporated directly into a substrate prior to or during manufacture of the article itself. In another embodiment, the substrate is a polymeric, cloth, or metallic material.

For example, in one embodiment a polymeric article is prepared by mixing a bioceramic composition with the polymeric substrate while the substrate is in a liquid or fluid form. The bioceramic/polymer material is then molded into the final desired shape or form. The amount of bioceramic composition incorporated into the polymeric substrate can be any suitable amount. In one embodiment, the bioceramic composition is added in an amount from about 1 wt % to about 35 wt % by total weight of the article. In another embodiment, the bioceramic composition is added in an amount from about 3 wt % to about 25 wt % by total weight of the article. In yet another embodiment, the bioceramic composition is added in an amount from about 5 wt % to about 15 wt % by total weight of the article. In a further embodiment, the bioceramic composition is added in an amount from about 7 wt % to about 13 wt % by total weight of the article. In another embodiment, the polymeric substrate is in the form of a cloth substrate, which is discussed in greater detail below.

The polymeric substrate can include any polymer that is useful for preparing an article that incorporates a bioceramic composition. For example, the polymeric substrate can include at least one elastomeric polymer or at least one non-elastomeric polymer. As used herein “polymeric” includes, but is not limited to, homopolymers, copolymers, cross-linked polymers and polymer systems, polymer blends that include continuous and/or dispersed phases, and the like.

Elastomers include, but are not limited to, viscoelastic polymers, such as, for example, natural rubbers, synthetic rubbers, rubbery, and rubber-like polymeric materials. One example of a synthetic rubber is polychloroprene (Neoprene). In one embodiment, the elastomer is selected from polychloroprene, nylon, a polyvinyl chloride elastomer, a polystyrene elastomer, a polyethylene elastomer, a polypropylene elastomer, a polyvinyl butyral elastomer, silicone, a thermoplastic elastomer, and combinations thereof.

Thermoplastic elastomers (TPEs) are composite materials obtained from the combination of an elastomeric material and a thermoplastic material. TPEs are elastomeric materials that are dispersed and crosslinked in a continuous phase of a thermoplastic material. Examples of conventional TPEs include Santoprene®, available from Advanced Elastomers Systems, Inc. and Sarlink® available from DSM Elastomers, Inc.

In one embodiment, the non-elastomer is selected from a group of polymers that includes, but is not limited to, polyoxybenzylmethylenglycolanhydride, polyvinyl chloride, polystyrene, polyethylene, polypropylene, polacrylonitrile, polyvinyl butyral, polylactic acid, and the like.

With respect to an article that includes a cloth substrate and a bioceramic composition, the bioceramic composition can be applied to the cloth by any process known in the cloth/fabric art using a liquid or fluid carrier that contains the bioceramic composition. For example, a silk-screen printing process can be employed. Silk-screen printing is a printing process which uses a form-referred to as a frame or sieve—that includes a fabric with a very fine mesh, which is left permeable to the ink in the areas of the image to be reproduced and impermeable in the other areas. In one embodiment, the bioceramic composition can be incorporated into an ink, which is then silk-screened onto at least a portion of the surface of the cloth substrate.

In another embodiment, the bioceramic composition is combined with one or more liquid polymers (e.g. polyester and/or the like). The bioceramic/polymer composition is then extruded using methods known in the art to form fibers that are used in preparing a cloth substrate.

The amount of bioceramic composition added to an ink or other liquid/fluid carrier can be any suitable amount. In one embodiment, the amount of the bioceramic composition ranges from about 1 wt % to about 35 wt % by total weight of the carrier and bioceramic composition. In another embodiment, the amount of the bioceramic composition ranges from about 3 wt % to about 25 wt % by total weight of the carrier and bioceramic composition. In yet another embodiment, the amount of the bioceramic composition ranges from about 5 wt % to about 15 wt % by total weight of the carrier and bioceramic composition. In a further embodiment, the amount of the bioceramic composition ranges from about 7 wt % to about 13 wt % by total weight of the carrier and bioceramic composition.

Cloth substrates useful herein include fabric or textile substrates prepared by any method known to one of skill in the cloth fabrication art. Such techniques include, but are not limited to, weaving, knitting, crocheting, felting, knotting, bonding, and the like. Suitable starting materials for the cloth substrates include natural or synthetic (e.g. polymeric) fibers and filaments. In one embodiment, the cloth substrate includes, but is not limited to, a material selected from wool, silk, cotton, canvas, jute, glass, nylon, polyester, acrylic, elastane, polychloroprene, expanded polytetrafluoroethylene-containing laminate fabrics (e.g. Gore-Tex® fabric), and combinations thereof.

With respect to an article that includes a metallic substrate, the bioceramic composition can be applied to the metal in a liquid/fluid form by any process known in the metal processing art. For example, the bioceramic composition can be incorporated into a liquid/fluid carrier, such as, but not limited to, a paint, sealant, varnish, and the like, and applied to at least a portion of the surface of the metallic substrate. The amount of bioceramic composition added to a paint or other liquid/fluid carrier can be any suitable amount. In one embodiment, the amount of the bioceramic composition added to a paint or other liquid/fluid carrier ranges from about 1 wt % to about 35 wt % by total weight of the carrier and bioceramic composition. In another embodiment, the amount of the bioceramic composition added to a paint or other liquid/fluid carrier ranges from about 3 wt % to about 25 wt % by total weight of the carrier and bioceramic composition. In yet another embodiment, the amount of the bioceramic composition added to a paint or other liquid/fluid carrier ranges from about 5 wt % to about 15 wt % by total weight of the carrier and bioceramic composition. In a further embodiment, the amount of the bioceramic composition added to a paint or other liquid/fluid carrier ranges from about 7 wt % to about 13 wt % by total weight of the carrier and bioceramic composition.

Suitable metallic substrates for use herein include any metallic substrate that is useful for preparing an article that incorporates a bioceramic composition. Exemplary metallic substrates include pure metals and alloys. In one embodiment, the metallic substrate is selected from zinc, molybdenum, cadmium, scandium, titanium, vanadium, chromium, manganese, iron, cobalt, nickel, copper, zirconium, niobium, ruthenium, rhodium, palladium, silver, tantalum, tungsten, rhenium, osmium, iridium, platinum, gold, aluminum, gallium, indium, tin, and the like.

Virtually any article that is capable of incorporating a bioceramic composition is suitable. In one embodiment, the article is selected from apparel (e.g. garments), jewelry, patches (e.g. patches that are fabricated to adhere to skin, such as transdermal patches, transdermal hydrogel patches, etc.), pads, insoles, bedding, body supports, foam rollers, lotions, soaps, tape, glassware, furniture, paints, inks, labels, carpets, mats, food and/or beverage containers, drink koozies (e.g. bottle or can), headware (e.g. helmets, hats, etc.), footwear (e.g. shoes, sneakers, sandals, etc.), earphones, and the like.

In another embodiment, the article is apparel selected from shirts, pants, shorts, dresses, skirts, jackets, hats, undergarments, socks, caps, gloves, scarves, diapers, and the like. In yet another embodiment, the article is jewelry selected from bracelets, necklaces, earrings, medallions, pendants, rings, and the like. In still another embodiment, the article is bedding selected from blankets, sheets, pillows, pillow cases, comforters, duvet covers, mattress covers, mattress pads, and the like. In another embodiment, the article is a body support selected from knee wraps, elbow supports, compression arm sleeves, compression leg sleeves, wrist wraps, and the like.

Optionally, articles can further include at least one light emitting diode (LED), at least one magnet, or a combination thereof.

Optionally, articles can further include one or more additional frequencies imprinted on the article using a frequency generator, i.e., a signal generating machine that emits an electromagnetic signal (audio or radio waves) at a selected frequency or frequencies. Examples of commercially available frequency generators include, but are not limited to Rife Machines (e.g. ProWave 101; F-Scan2; TrueRife F-117; Wellness Pro 2010; Global Wellness; GB4000; GB4000 BCX Ultra; and the like. In general, frequency generators produce selected frequencies that are then transmitted through a connecting cable to a commercially available frequency imprinting plate (e.g. SP9 or SP12 vortex frequency imprinting plates). In one embodiment, the frequency or frequencies range from about 0.05 Hz to about 20 MHz. In another embodiment, the frequency or frequencies range from about 5 Hz to about 5 MHz. In a further embodiment, the frequency or frequencies range from about 100 Hz to about 0.1 MHz. In yet another embodiment, the frequency or frequencies range from about 1 KHz to about 10 KHz. The article to be imprinted with the selected frequency or frequencies is exposed to the frequency emitted by the generator. To accomplish this, the article may be placed on the imprinting plate and exposed to the signal of the selected frequency or frequencies for imprinting. In one embodiment, the imprinting process takes about 5-10 minutes per cycle depending upon the amount of frequencies to be imprinted and the selected imprinting program. In another embodiment, the imprinting process takes about 5 minutes, 6 minutes, 7 minutes, 8 minutes, 9 minutes, or 10 minutes per cycle depending upon the amount of frequencies to be imprinted and the selected imprinting program. Imprinted articles may transmit the frequency imprints to a user upon contact in conjunction with the waves emitted from the bioceramic composition that is incorporated into the article.

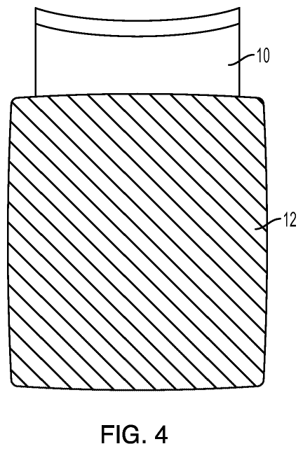

Another embodiment includes a method of freshening a beverage by exposing the beverage to a container that contains or is adjacent to a bioceramic composition. For example, one method may reduce furfural content in beer by exposing beer containing furfural to a bioceramic composition. For example, as shown in FIG. 4, the bioceramic composition can be incorporated into or applied to at least a portion of the surface of the beer's container 10, such as through a beverage koozie 12. In one embodiment, the bioceramic composition is mixed with a foam precursor that is later used to form the koozie 12. In another embodiment, the bioceramic composition is applied to at least a portion of the surface of the koozie 12 by any coating method known in the art (e.g. applying a liquid carrier containing the bioceramic composition to the koozie 12 by spraying, painting, dipping, and the like). The amount of bioceramic composition incorporated into or applied on the koozie 12 can be any suitable amount. In one embodiment, the amount of the bioceramic composition ranges from about 1 wt % to about 35 wt % by weight of the foam in the koozie. In another embodiment, the amount of the bioceramic composition ranges from about 3 wt % to about 25 wt % by weight of the foam in the koozie. In yet another embodiment, the amount of the bioceramic composition ranges from about 5 wt % to about 15 wt % by weight of the foam in the koozie. In yet another embodiment, the amount of the bioceramic composition ranges from about 7 wt % to about 13 wt % by weight of the foam in the koozie.

The koozie 12 is then placed around a bottle or can 10 containing beer tainted with furfural. The bottle or can 10 remains in the koozie 12 for a time period suitable to reduce the furfural content. In one embodiment, the time period is on the order of minutes (e.g. less than 5 minutes, 5 minutes, 10 minutes, 15 minutes, greater than 15 minutes, etc.). The bioceramic composition can also be incorporated into or on the surface of a beverage container (e.g. can, bottle, or the like) or into or on a label or sticker to be affixed to a bottle or can containing beer or another beverage to be treated. Water or any other beverage can also be treated with the bioceramic composition in a similar manner.

The following non-limiting examples serves to further illustrate the present invention.

### EXAMPLES

### Example 1: Preparation of a Bioceramic Powder Composition

The kaolinite is extracted in the outskirts of the city of Parintins, in the Amazon State, Brazil. The city is located in the Lower Amazon Region (coordinates: latitude: 2° 37′ 42″ south/longitude: 56° 44′ 11″ west of Greenwich, 50 m above sea level).

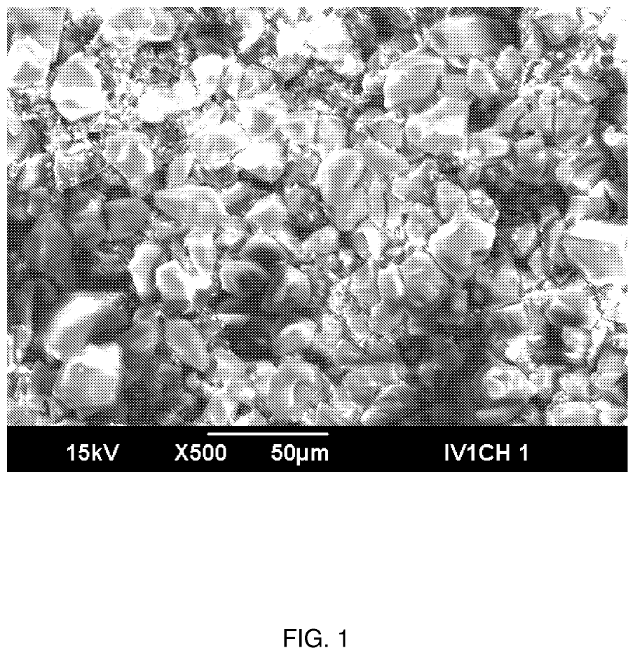

The extracted kaolinite is washed with hydrogen peroxide (H₂O₂) and allowed to dry. The dried kaolinite is then finely ground and mixed with tourmaline; aluminum oxide (Al₂O₃); silicon dioxide (SiO₂); and zirconium oxide (ZrO₂) until a homogeneous mixture is achieved. The resulting bioceramic composition contains 50 wt % kaolinite, 10 wt % tourmaline, 18 wt % aluminum oxide, 14 wt % silicon dioxide, and 8 wt % zirconium oxide. The electron microscopy image in FIG. 1 demonstrates that the composition includes bioceramic particles smaller than 1 micrometer.

### Example 2: Impregnating Fabric

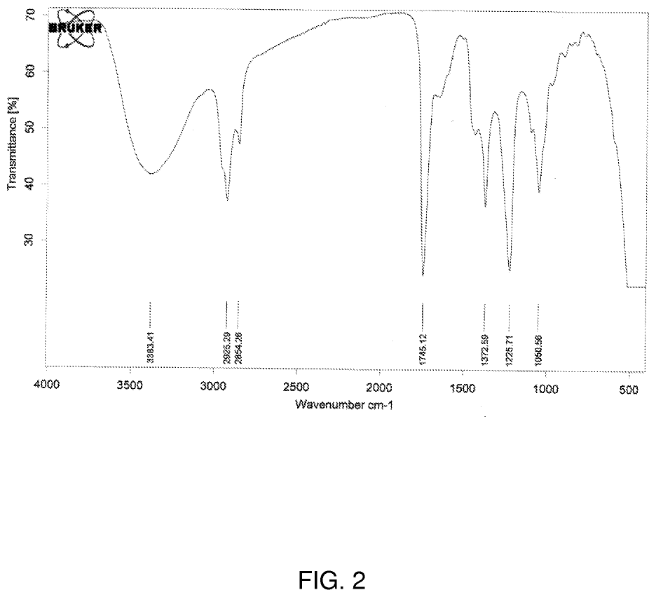

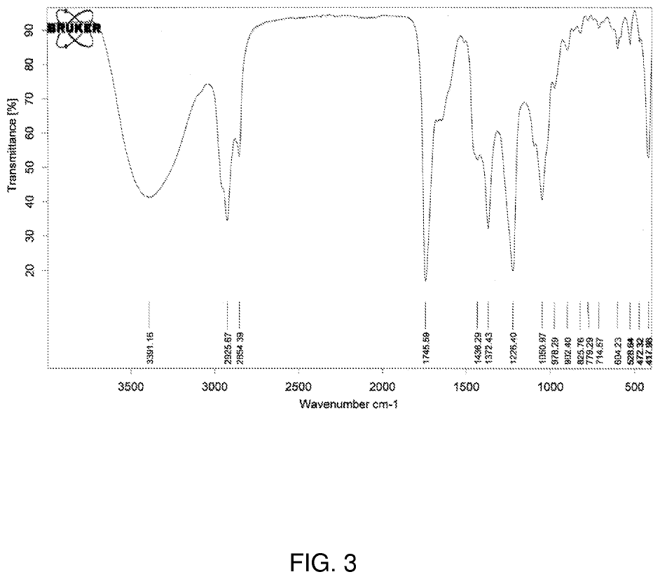

A cloth substrate that includes 88 wt % polyamide and 12 wt % elastane was obtained. A bioceramic composition prepared according to the method of Example 1 was incorporated into a plastisol ink in an amount of 10 wt % and mixed. The mixture was applied to the cloth substrate using a traditional silkscreen process. FIG. 2 is a graph of the spectral transmittance of the bioceramic composition deposited on the cloth substrate. FIG. 3 is a graph of the spectral transmittance of the bioceramic composition impregnanted in fabric. The numbered peaks in FIGS. 2 and 3 indicate that the bioceramic composition absorbs infrared radiation when incorporated into fabric.

### Example 3: Beverage Freshness

A beverage koozie that includes closed-cell extruded polystyrene foam was obtained. A bioceramic composition prepared according to the method of Example 1 was incorporated into a plastic-based paint in an amount of 10% by weight of the paint composition and mixed. The mixture was applied to the interior surface of the koozie. An extruded plastic composition containing the bioceramic composition in an amount of 10% by weight of the plastic was also prepared using a traditional extrusion process. The extruded plastic composition was placed in the bottom of the koozie.

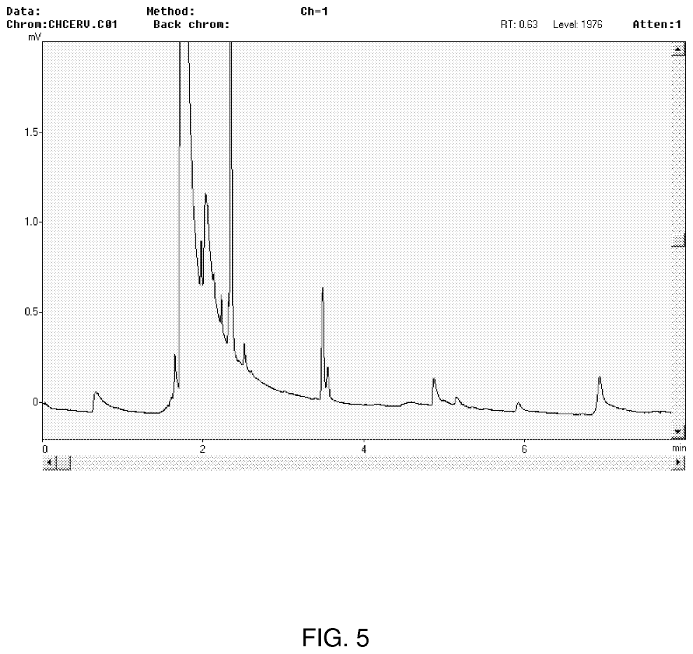

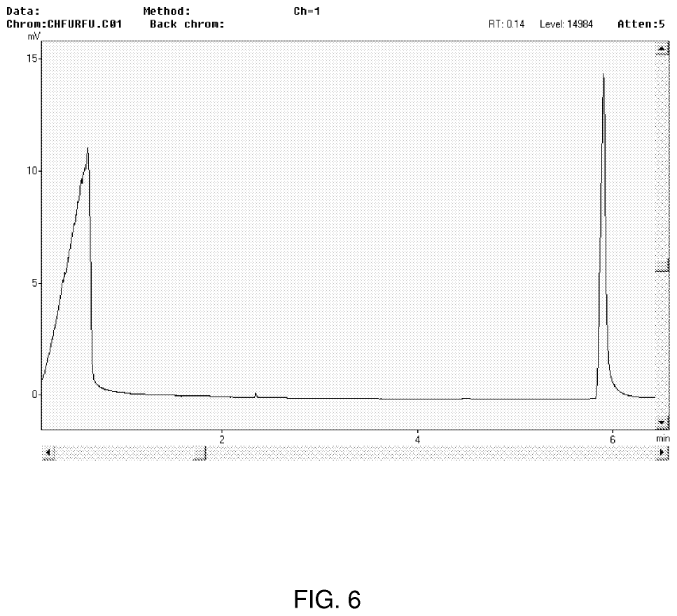

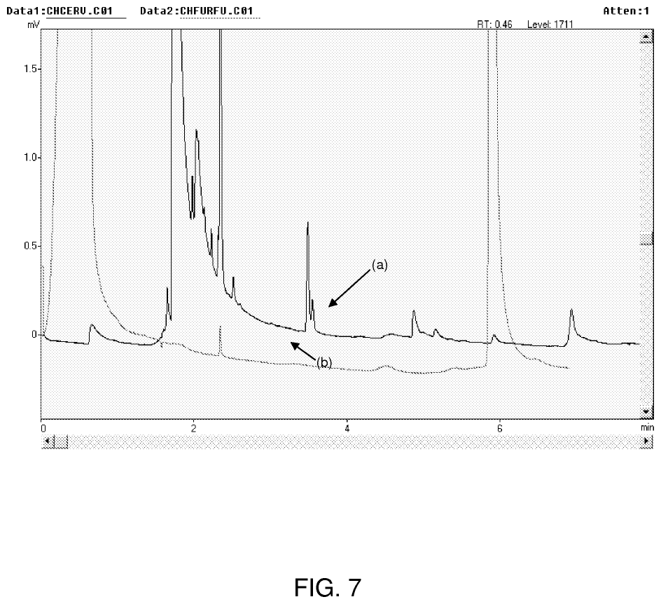

A 10 mL sample of beer that had not yet been exposed to the bioceramic composition in the koozie was analyzed using gas chromatography-mass spectrometry (GC-MS) (FIG. 5). A comparison of FIG. 5 with FIG. 6 (mass spectrum of furfural) revealed the presence of peaks corresponding to furfural in the beer sample (FIG. 7).

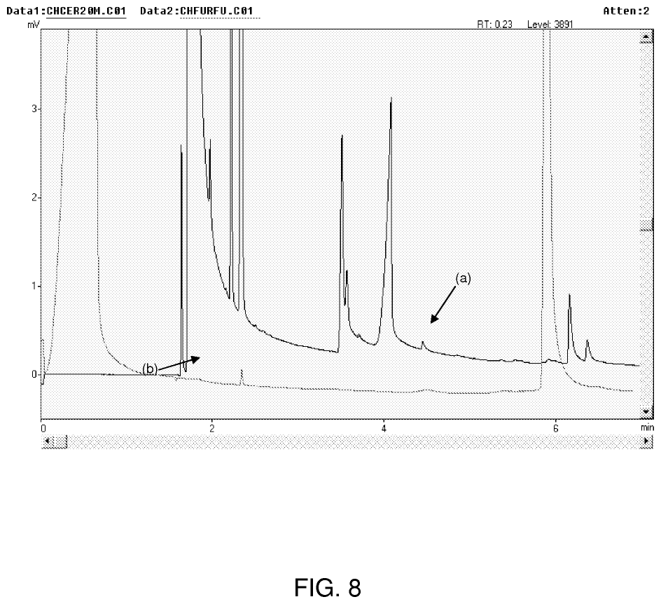

A can containing the same beer from which the sample was obtained was then placed inside the bioceramic-treated koozie for 10 minutes. The treated koozie covered about ⅔ of the outer surface of the can. Immediately after the 10-minute exposure period, a sample of beer was withdrawn from the can and analyzed using GC-MS (FIG. 8). The analysis revealed the disappearance of furfural from the beer. As shown in FIG. 8, the mass spectrum of the treated beer contained no peaks corresponding to furfural.

All publications cited in the specification, both patent publications and non-patent publications, are indicative of the level of skill of those skilled in the art to which this invention pertains. All these publications are herein fully incorporated by reference to the same extent as if each individual publication were specifically and individually indicated as being incorporated by reference.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the following claims.

What is claimed is:

1.-20. (canceled)

21. An article comprising: (a) a substrate, and (b) a bioceramic composition comprising particles dispersed throughout the substrate, wherein the bioceramic composition comprises: (i) 45 wt % to 55 wt % kaolinite; (ii) 5 wt % to 15 wt % tourmaline; (iii) 11 wt % to 19 wt % silicon dioxide (SiO₂); (iv) 3 wt % to 18 wt % aluminum oxide (Al₂O₃); and (v) an additional oxide.

22. The article of claim 21, wherein the substrate comprises a metallic substrate, a cloth substrate, or a polymeric substrate.

23. The article of claim 22, wherein the polymeric substrate comprises at least one elastomeric polymer.

24. The article of claim 23, wherein the elastomeric polymer is a natural rubber.

25. The article of claim 23, wherein the elastomeric polymer is a synthetic rubber or rubber-like material.

26. The article of claim 24, wherein the synthetic rubber comprises polychloroprene.

27. The article of claim 23, wherein the elastomeric polymer comprises polychloroprene, nylon, a polyvinyl chloride elastomer, a polystyrene elastomer, a polyethylene elastomer, a polypropylene elastomer, a polyvinyl butyral elastomer, silicone, a thermoplastic elastomer, or a combination thereof.

28. The article of claim 22, wherein the polymeric substrate comprises at least one non-elastomeric polymer.

29. The article of claim 28, wherein the non-elastomeric polymer comprises polyoxybenzylmethylenglycolanhydride, polyvinyl chloride, polystyrene, polyethylene, polypropylene, polacrylonitrile, polyvinyl butyral, or polylactic acid.

30. The article of claim 22, wherein the polymeric substrate comprises a homopolymer, a co-polymer, or a cross-linked polymer.

31. The article of claim 22, wherein the metallic substrate comprises pure metal.

32. The article of claim 22, wherein the metallic substrate comprises a metal alloy.

33. The article of claim 22, wherein the metallic substrate comprises zinc, molybdenum, cadmium, scandium, titanium, vanadium, chromium, manganese, iron, cobalt, nickel, copper, zirconium, niobium, ruthenium, rhodium, palladium, silver, tantalum, tungsten, rhenium, osmium, iridium, platinum, gold, aluminum, gallium, indium, or tin.

34. The article of claim 21, wherein the additional oxide comprises zirconium oxide (ZrO₂).

35. The article of claim 22, wherein the polymeric substrate comprises a liquid polymer.

36. The article of claim 35, wherein the liquid polymer comprises polyester.

37. The article of claim 22, wherein the cloth substrate comprises a fabric or a textile.

38. The article of claim 37, wherein the cloth substrate comprises wool, silk, cotton, canvas, jute, glass, nylon, polyester, acrylic, elastane, polychloroprene, expanded polytetrafluoroethylene-containing laminate fabric, or a combination thereof.

39. The article of claim 21, further comprising a light emitting diode, a magnet, or a combination thereof.

40. A method for preparing a polymeric article comprising the steps of:
(a) mixing a bioceramic composition comprising from about 45 wt % to about 55 wt % kaolinite (Al₂Si₂O₅(OH)₄); from about 5 wt % to about 15 wt % tourmaline; from about 3 wt % to about 18 wt % aluminum oxide (Al₂O₃); from about 11 wt % to about 19 wt % silicon dioxide (SiO₂); and from an additional oxide, wherein the amounts are by total weight of the bioceramic composition, with a polymeric substrate while the substrate is in a liquid form; and
(b) molding the polymeric substrate into a final shape.
